(19) United States
(12) Patent Application Publication
(10) Pub. No.: US 2006/0088330 A1
(43) Pub. Date: Apr. 27, 2006

(54) Image forming apparatus

(75) Inventor: Shinsuke Fujita, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KONICA MINOLTA BUSINESS TECHNOLOGIES, INC.

(21) Appl. No.: 11/166,206

(22) Filed: Jun. 27, 2005

(30) Foreign Application Priority Data
Oct. 27, 2004 (JP) JP2004-312089

(51) Int. Cl. G03G 15/20

(52) U.S. Cl. 399/70

(57) ABSTRACT

An image forming apparatus, provided with a fixing device that transports the recording material while gripping it using a heating member and a pressing member and that carries out fixing by heating from the heating member, has a driving device for rotating the heating member and the pressing member and a controller that controls the driving device in an idling state so that the heating member and the pressing member turn into a printing standby state during which the heating member and the pressing member carry out an idling rotation when a specific external operation is made.

This application claims priority from Japanese Patent Application No. 2004-312089 filed on Oct. 27, 2004, which is incorporated hereinto by reference.

### BACKGROUND OF THE INVENTION

The present invention relates to an image forming apparatus in use of an electro-photographic method.

In an image forming apparatus of the electro-photographic method, a thermal fixing means that carry out thermal fixing are used very widely as the fixing means that fixes an unfixed toner image on a recording medium. It is very common that the thermal fixing means requires time after supplying the power to it until it reaches a specific fixing temperature. In other words, in a regular image forming apparatus, after the main power switch has been switched ON, the image forming apparatus cannot go into the state in which image forming is possible unless a certain has elapsed.

On the other hand, from the point of view of suppressing the power consumption or of preventing the effect of flickering on the room illumination, it is preferable to suppress the power supply to the image forming apparatus as much as possible when it is not being used. In most image forming apparatuses if the apparatus is not started again within a specific duration after the end of image formation, control is carried out so that the power supply to the fixing means is either switched OFF or is reduced to a low level by going to the power saving mode. Next, at the time of using the image forming apparatus, power supply is started to the fixing means of the image forming apparatus that is in the power saving mode, and control is carried out of starting the image forming apparatus by carrying out warming up during which the temperature of the fixing means is raised to a specific fixing temperature.

A certain amount of time is required for raising the temperature of the fixing means up to a specific temperature and hence there is the problem that the period from making the operation of giving the image forming command until the first image is output, that is, the waiting time, becomes long. In view of this, technical developments have been carried out for shortening the waiting time.

In order to shorten the waiting time, it is necessary to raise to a specific temperature not only the heating member but also the pressing member in a short time. Therefore, measures have been adopted concerning the heating members, such as reducing the heat capacity by using a pipe or a belt with thin wall thickness, etc. In addition, while the pressing members are generally formed using heat resistant elastic layers such as silicone rubber, etc., on a metallic core, their heat capacity is large, and a certain length of time is needed for raising the temperature of the heating members. If the temperature of the pressing member is low, the heat of the heating member is absorbed by the pressing member, and since this causes insufficient fixing because the temperature of the heating member does not rise sufficiently, it is necessary that even the temperature of the pressing member is raised above a certain value. As a consequence, measures were being taken such as providing a heat source inside the pressing member, or of slowly rotating the heating member and the pressing member during idling.

However, these measures are not sufficient from the point of view of energy saving because power consumption for heating or driving is accompanied even when the image formation is not being made.

In Patent Document 1, it has been proposed to rotate periodically or continuously the rotating pressing member during the idling period of the image forming apparatus.

In Patent Document 2, it has been proposed to raise the temperature of the fixing means to a high level if a specific external operation is present during the idling state.

In Patent Document 3, it has been proposed to carry out idling rotation for a specific duration after the completion of warming up, and to adjust the duration of that idling rotation according to the rate of temperature rise during the warming up process.

Patent Document 1: Japanese Unexamined Patent Application Laid Open No. Hei 11-119588

Patent Document 2: Japanese Unexamined Patent Application Laid Open No. 2002-207390

Patent Document 3: Japanese Unexamined Patent Application Laid Open No. 2004-12759

The methods disclosed in Patent Documents 1 and 3 are not sufficient from the point of view of energy saving because drive is provided when image formation is not being made.

In the method disclosed in Patent Document 2, since the fixing means is being started due to an external operation made as a preparatory operation for image formation, not only that the purpose of suppressing the energy consumption during the idling state has been achieved, but also the purpose of reducing the waiting time has been achieved because the image formation is started within a short time after the “Copy” button is operated or after a command for image formation is issued by an external equipment.

However, even the method disclosed in Patent Document 2 is not sufficient for reducing the waiting time while also obtaining good fixing without poor fixing.

In an image forming apparatus having a power saving mode, generally, in the power saving mode, only the control section is operated and the power supply of the drive related section is kept in the switched OFF state. Since the largest amount of electric power is consumed for the heating of the fixing means in an image forming apparatus, the energy consumption of the image forming apparatus can be reduced effectively by putting the apparatus in the power saving mode when the apparatus is idle. Therefore, from the point of view of the operating efficiency of reducing the waiting time and from the point of view of reducing the energy consumption, it is necessary to reduce the time taken after the starting of the image forming apparatus from the energy saving mode until it goes into the state in which image formation becomes possible.

To this end, as has been explained above, although measures are taken such as reducing the heat capacities of the heating member and the pressing member, since the heat capacity of the pressing member is far larger than the heat capacity of the heating member, the heat generated in the heating member is absorbed in the pressing member thereby lowering the rate of temperature rise of the heating member and lengthening the time taken to reach the temperature at which proper fixing becomes possible. This phenomenon becomes particularly significant when the heat capacity of the heating member is made small in order to shorten the waiting time. In other words, even when the temperature of the fixing means is raised due to an external operation made in preparation for image formation, as in the method disclosed in Patent Document 2, since the temperature of the pressing member would not have increased sufficiently, the heat of the heating member is absorbed by the pressing member thereby lowering the temperature of the heating member and hence making it likely to cause insufficient fixing.

### SUMMARY OF THE INVENTION

An object of the present invention is to solve the above problems and to provide an image forming apparatus of the energy saving type that reduces the waiting time and also carries out sufficient fixing of the image on the recording medium.

The above object of the present invention can be achieved by having the following configuration.

An image forming apparatus, provided with a fixing means that transports the recording material while gripping it using a heating member and a pressing member and that carries out fixing by heating from the heating member, has the feature that it comprises a driving means for rotating the heating member and the pressing member and a control means that controls the driving means in an idling state so that the heating member and the pressing member turn into a printing standby state during which the heating member and the pressing member carry out an idling rotation when a specific external operation is made.

### BRIEF DESCRIPTION OF THE DRAWINGS

FIG. 1 is a diagram showing the mechanical configuration of an image forming apparatus according to a preferred embodiment of the present invention;

FIG. 2 is a diagram showing the block diagram of the control system of the image forming apparatus according to the embodiment of the present invention;

FIG. 3 is a state transition diagram during the control of the image forming apparatus according to the embodiment of the present invention; and

FIG. 4 is a diagram showing the experimental results of the temperature rise of the pressing member due to the drive of the fixing means.

### DETAILED DESCRIPTION OF THE PREFERRED EMBODIMENT

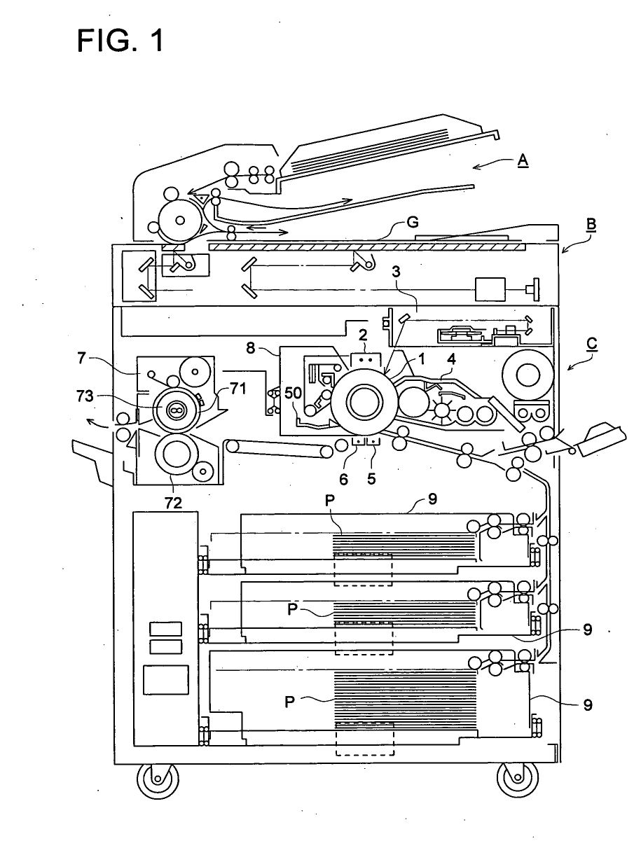

FIG. 1 shows the mechanical configuration of the image forming apparatus according to a preferred embodiment of the present invention.

The image forming apparatus includes an automatic document transportation apparatus A, an image reading section B, and an image forming section C. In the image forming section C, the numeral 1 indicates the photosensitive body, and, from the point of view of environment friendliness and cost, although it is preferable to use an organic photosensitive body having a photosensitive layer made of an organic photoconductive material dispersed in resin, it is not necessary to restrict to this but it is possible to use any widely known photosensitive body.

In addition, it is not necessary to restrict the photosensitive body 1 to be a drum shaped photosensitive body as is shown in the figure, but it can also be of the belt shape. The numeral 2 in the figure indicates the charging means that form a uniform electric potential on the surface of the photosensitive body 1. It is preferable to use as the charging means a scorotron charger having a control grid and a discharging electrode, or a charger of the contact charging type in which a roller with voltage applied to it is used for charging.

The exposing means that exposes the photosensitive body 1 is indicated by the numeral 3 in the figure. It is possible to use as the exposing means a scanning type exposing apparatus that has an optical scanning system constituted by a laser diode as the light source, a polygon mirror, a lens, and a mirror, or, an optical scanning apparatus having an LED array and image formation optical fibers, but it is not necessary to restrict to these and any widely known exposing means can be used. The exposing means 3 carries out dot exposure of the photosensitive body 1 according to the image data.

The developing means is indicated by the numeral 4 in the figure, and stores a two-component developer or a single component developer. The developing means 4 develops the electrostatic latent image on the photosensitive body 1 and forms a toner image on the photosensitive body 1. The numeral 5 indicates a transfer means having a corona charger. The transfer means 5 charges the recording material P with a polarity opposite to that of the toner on the photosensitive body 1, and transfers the toner image onto the recording medium P. The numeral 6 indicates a separating means having a corona charger that carries out AC corona charging of the recording medium P thereby discharging the electrostatic charge on the recording medium P and separating it from the photosensitive body 1.

The fixing means is indicated by the numeral 7 in the figure, and fixes the toner image by gripping and transporting the recording medium P by means of a heating member roller 71 having a built-in heat source and a pressing member 72 that presses against the heating roller 71.

A heat generating lamp such as a halogen lamp, an inductive heat generating body that generates heat due to electromagnetic induction, or a resistive heat generating body is used as the heat source 73. A heating roller or a heating belt is used as the heating member 71, and it is preferable that it has a low heat capacity in order to enhance the response characteristics during temperature control, and a metal pipe or a metal belt with a wall thickness of 0.2 to 1.0 mm is used preferably. It is possible to use a heating member 71 that has been provided with a releasing layer such as a fluorocarbon resin layer on the surface. In addition, it is also possible to provide a heat resistant elastic layer made of silicone rubber, etc., on the metal pipe or metal belt constituting the heating member. The pressing member 72 is a roller provided with a heat resistant elastic layer made of silicone rubber, etc., on a metallic core. Also, it is possible to use a foamed silicone rubber layer as the heat resistant elastic layer. It is also possible to provide a releasing layer such as a fluorocarbon resin layer on the surface of the heat resistant elastic layer of the pressing member 72.

The numeral 8 in the figure indicates a cleaning means. Toner that has not been transferred or toner that has remained after transferring would be adhered to the surface of the photosensitive body 1 after transferring the toner image to the recording medium, and it is necessary to clean the photosensitive body 1 before carrying out the subsequent image formation. The cleaning means 8 has a cleaning blade made of an elastic material such as urethane rubber, etc.

The numeral 9 in the figure is a recording medium storage means which is a tray or a cassette storing the recording medium P, and it is possible to take out the recording medium P from the image forming apparatus and to replenish the recording medium P.

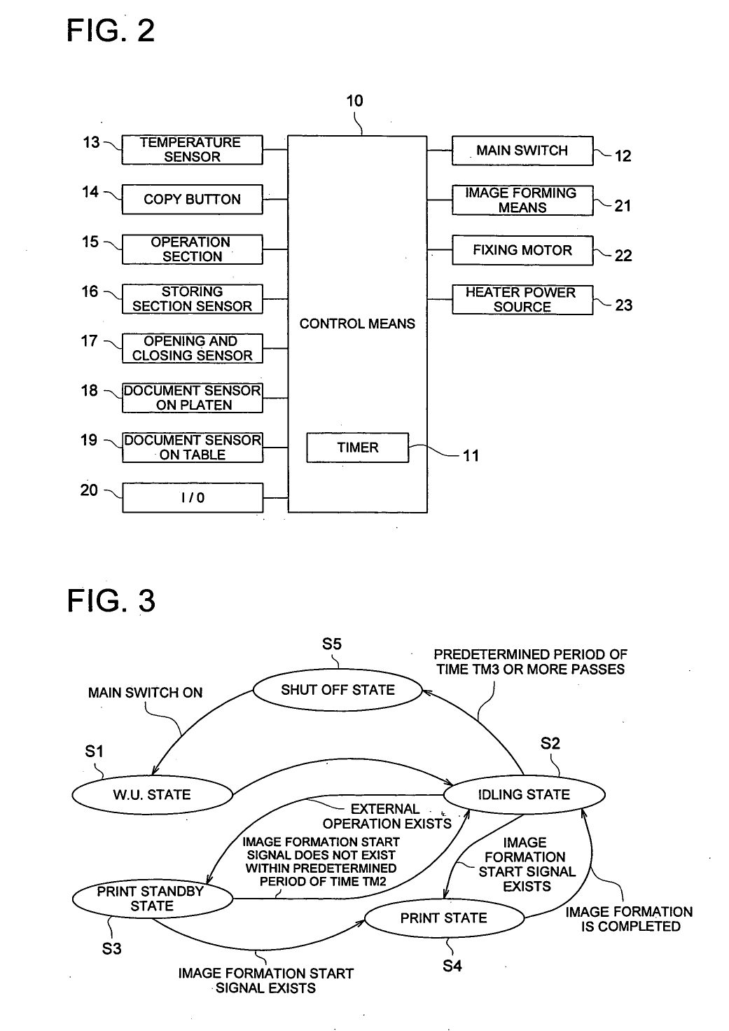

FIG. 2 is a block diagram showing the electrical configuration of the image forming apparatus according to the preferred embodiment of the present invention.

In this figure, the numeral 10 indicates a control means constituted by a microcomputer and having a timer 11. Further, 12 is the main power switch, 13 is the temperature sensor that senses the surface temperature of the heating member 71, 14 is the “Copy” button, 15 is the operation section for setting the number of copies, the magnification, the density, etc., 16 is the storage detection sensor that detects the insertion and removal of the recording medium storage section 9, 17 is open and close detection sensor that detects the open or closed condition of the document cover (the automatic document transportation apparatus A in the example shown in this figure), 18 is the document presence sensor that detects when a document has been placed on top of the platen glass G of the image reading section, 20 is the input and output interface that carries out transmission and reception with external equipment such as personal computers, facsimiles, etc., 21 is the image forming means that forms a toner image on the photosensitive body 1 and that is constituted by the charging means 2, the exposing means 3, and the developing means 4, etc., 22 is the fixing motor that provides the rotational drive for the heating member 71 and the pressing member 72, and 23 is the heater power supply that supplies electric power to the heat source 73. The fixing motor 22 rotates and transmits rotational driving force to at least one of the heating member 71 and the pressing member 72 and it is possible to drive the heating member 71 or the pressing member 72 while causing the other of the two to carry out slave rotation.

The operations are made according to the state transition diagram shown in FIG. 3 of the image forming apparatus shown in FIG. 1 and FIG. 2.

In FIG. 3, the warming up state S1 is the state in which not only power is supplied from the heater power supply 23 to the heat source 73 but also the heating member 71 and the pressing member 72 are rotated by the fixing motor 22, and the surface temperature of the heating member 71 is raised to a specific temperature TP1, for example, 170° C. The warming up is started (S1) when the heater power supply 23 is switched ON and the fixing motor is driven due to pressing ON the main power switch 12. The warming up is completed when the temperature of the heating member 71 is detected by the temperature sensor 13 to have reached the specific temperature TP1, after which the apparatus goes into the idling state (S2).

The idling state S2 is the state in which the fixing means 7 is made ready when an external operation for executing the image formation is present so that it is possible to carry out image formation within a short time, and the power supplied to the heat source 73 thereby maintaining the heating member 71 at a specific temperature TP2, for example, 180° C. In the idling state S2, the control of maintaining the temperature of the heating member 71 at a specific temperature TP2 is carried out by the control means 10 based on the temperature detected by the temperature sensor 13. The fixing motor is switched OFF during the idling state S2, and the rotations of the heating member 71 and the pressing member 72 are stopped.

After changing to the idling state S2, the state of the apparatus is changed from the idling state S2 to the printing state S4 and the image formation is carried out if there is an operation of the “Copy” button or there is an image formation command from the input and output interface 20 within a specific time duration TM1, for example, 3 minutes.

As is well known, in the printing state S4, the fixing motor 22 and the fixing power supply are switched ON, and not only the rotational drive is given to the heating member 71 and the pressing member 72 but also the temperature of the heating member 71 is maintained at a specific temperature TP4, for example, 190° C. After the image formation is completed, the apparatus goes into the idling state S2.

The printing standby state S3 is the state in which the heating member 71 and the pressing member 72 are given a rotational drive. This rotational drive in the printing standby state S3 is an idling rotation, that is, a rotation during which no fixing is done. Further, during the idling rotation, includes the rotation of the heating roller and the rotation of the heating belt. In addition, in the printing standby state S3, control is carried out by supplying electric power to the heat source 73 thereby maintaining the temperature of the heating member 71 at a specific temperature, and it is preferable that the temperature of the heating member 71 is maintained at a slightly higher value of temperature TP3, for example, 190° C. than the temperature in the idling state S2.

After transiting to the idling state S2, the apparatus changes to the printing standby state when any of the following external operations are made.

(1) In the operation panel, the operation panel touching operations for setting the number of copies, print density, magnification, other applied functions, or the output mode is detected in the operation section 15;

(2) The operations of removing and inserting of the recording medium storage section 9 is detected by the storage section sensor 16;

(3) opening and closing operation of the document cover, that is, of the automatic document transporting apparatus A is detected by the open and close detection sensor 17;

(4) Operation of placing the document on the feeding tray of the automatic document transporting apparatus A is detected by the document presence sensor 18; and

(5) Operation of placing the document on the platen glass G is detected by the document sensor 19.

These external operations are made by the operator as the preparatory operations for image formation, and normally, the image formation is done after making these operations by pressing finally the “Copy” button 14.

Since the apparatus goes into the printing state S4 after transiting to the printing standby state S3 due to any of the above operations (1) to (5), the image formation is done immediately when the “Copy” button 14 is pressed, and this in effect shortens the waiting time. In this case, since the pressing member 72 is rotated during the printing standby state S3, the surface of the pressing member would have reached a sufficiently high and uniform temperature and hence satisfactory fixing is done.

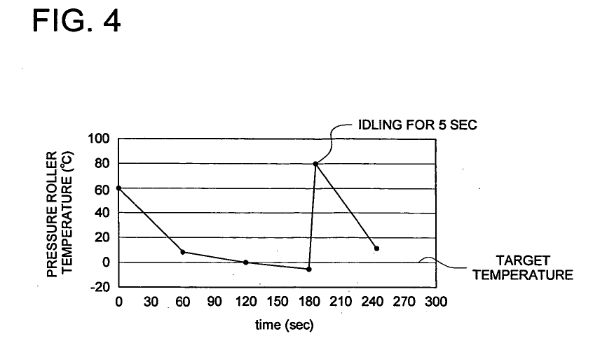

FIG. 4 is a diagram showing the experimental results of the temperature rise of the pressing member 72 due to the drive of the fixing means 7. In other words, as is shown in FIG. 4, although the temperature of the pressing member gradually decreases if the heating member 71 and the pressing member 72 are left in the halted state, it has been confirmed that the temperature of the pressing member 72 reaches the target value if the pressing member is rotated for 5 seconds.

Further, in case an image formation command is received in the input and output interface 20 within a specific time period TM1 after the apparatus has gone into the idling state S2, although the apparatus goes into the printing state S4 as has been explained above, the apparatus goes into the printing standby state S3 in case an image formation command is received in the input and output interface 20 after the elapse of a specific period of time TM1 after the apparatus has gone into the idling state S2.

The state of the apparatus changes to the printing state and the image forming is started when the operation of the “Copy” button 14 is made within a specific period of time TM2, for example, 5 seconds, after the apparatus has gone into the printing standby state S3.

When the apparatus has gone into the printing standby state due to a signal from the input and output interface 20, the apparatus automatically goes into the printing state S4 after the heating member 71 and the pressing member 72 are given a rotational drive for a specific period of time TM2.

When image formation is done by transiting directly from the idling state S2 to the printing state S4, since the temperature rise of the heating member is larger when compared to the case of transiting to the printing state via the printing standby state S3, the time taken until the image is actually formed will be slightly longer.

If there is no operation of the “Copy” button 14 within the specific period of time TM2 after the transition has been made to the printing standby state S3, the apparatus transits to the idling state S2 and the rotations of the heating member 71 and the pressing member 72 are stopped. In other words, the state of the apparatus returns to the idling state S2 in case only the preparatory operations are made but there is no printing start command.

When the external operations (1) to (5) are made several times in succession within a specific time interval TM1 in the idling state S2, the specific time interval TM2 does not get extended due to the multiple external operations, but the specific time interval TM1 is counted from the first external operation that was made.

The apparatus goes into the shut off state S5 if the idling state S2 continues for a specific period of time TM3 longer than the specific period of time TM1, for example, 10 minutes or more. It is possible for the user to change the setting of the length of the specific time interval TM3.

The shut off state S5 corresponds to the energy saving mode during which only the control means 10 and the input and output interface 20 will be operating and all other power supplies will be put in the switched OFF state. The apparatus transits to the warming up state S1 if there is an operation of the main switch 12 or if an image forming command is received in the input and output interface 20 while in the shut off state S5.

Because of the above embodiment, it is possible to realize an image forming apparatus in which the waiting time is shorted and which also can carry out satisfactory fixing because it is possible to use a heating member with a sufficiently small heat capacity.

Because of the above embodiment, it is possible to carry out satisfactory fixing without poor fixing because the fixing is carried out using a heating member and a pressing member that have reached a sufficiently high temperature.

Because of the above embodiment, it is possible to lower the energy consumption of the image forming apparatus because there is no unnecessary drive of the fixing means.

Because of the above embodiment, in particular, it is possible to realize an image forming apparatus that has a short waiting time and also has reduced energy consumption.

What is claimed is:

1. An image forming apparatus having a fixing device for interposing and conveying a recording material by a heat applying member and a pressure applying member, and for fixing the recording material by applying heat with the heat applying member, the image forming apparatus comprising:
(a) a driving device for driving the heat applying member and the pressure applying member; and
(b) a controller for controlling the driving device,
wherein when a predetermined external operation is carried out during an idling state of the fixing device, the controller controls the driving device so that the fixing device turns into a printing standby state during which the heat applying member and the pressure applying member carry out an idling rotation.

2. The image forming apparatus of claim 1, wherein the controller controls during the printing standby state so that the heat applying member is heated to a predetermined temperature higher than a temperature in the idling state.

3. The image forming apparatus of claim 1, wherein the predetermined external operation is a preparation operation for image formation carried out by an operator.

4. The image forming apparatus of claim 3, wherein the predetermined external operation is any one of an operation in which at least one of a print quantity set, a print density set, a magnification set, other application function set, and an output mode set is carried out at an operation section.

5. The image forming apparatus of claim 3, wherein the predetermined external operation is an insertion or removal operation of a recording material storing section.

6. The image forming apparatus of claim 3, wherein the predetermined external operation is an operation for placing an original document.

7. The image forming apparatus of claim 6, wherein the predetermined external operation is an opening or closing operation of a platen cover.

8. The image forming apparatus of claim 6, wherein the predetermined external operation is a placing operation of an original document on an automatic document feeder or a platen glass.

9. The image forming apparatus of claim 3, wherein the predetermined external operation is an instruction of image formation received from an external instrument.

10. The image forming apparatus of claim 1, wherein when there is received an external operation to instruct image formation within a predetermined period of time in the printing standby state, the controller controls the fixing device to turn into a print state, and when there is not received the external operation to instruct the image formation within the predetermined period of time, the controller controls the fixing device to turn into the idling state.

11. The image forming apparatus of claim 1, wherein the heat applying member comprises a metal pipe or a metal belt having a thickness of 0.2 mm to 1.0 mm.
